(19) United States
(12) Patent Application Publication
(10) Pub. No.: US 2001/0008546 A1
(43) Pub. Date: Jul. 19, 2001

(54) Data compressing apparatus

(76) Inventors: Kiyoshi Fukui, Mie (JP); Masayuki Tokumitsu, Nara (JP)

Correspondence Address: VENABLE, Post Office Box 34385, Washington, DC, 20043-9998, US

(21) Appl. No.: 09/736,197

(22) Filed: Dec. 15, 2000

(30) Foreign Application Priority Data
Jan. 19, 2000 (JP) 2000-14039
Oct. 27, 2000 (JP) 2000-327984

(51) Int. Cl. H04B 1/66; H04N 7/12; H04N 11/02; H04N 11/04

(52) U.S. Cl. 375/240.27

(57) ABSTRACT

A data compressing apparatus which can reduce a processing load associated to a data compressing process. The data compressing apparatus is used in a data transmitting apparatus for performing a data transmission, and includes a transmission mode selecting circuit for selecting the first transmission mode or second transmission mode in accordance with information indicating a kind of input data, a data compressing circuit for compressing the input data and transmitting it to a data output terminal, and a switch for allowing the input data to be transmitted to the data output terminal in accordance with the first transmission mode and allowing the input data to be transmitted to a data compressing circuit in accordance with the second transmission mode. The transmission mode is selected by the transmission mode selecting circuit on the basis of the signal indicative of the kind of input data. Whether the data compression is performed by the data compressing circuit or not is discriminated in accordance with the kind of input data. The load of the compressing process, therefore, can be reduced.

### BACKGROUND OF THE INVENTION

1. Field of the Invention

The invention relates to a data compressing apparatus for use in a data transmitting apparatus that transmits data by using a transmission path of a narrow band, operative to raise a transmission efficiency.

2. Description of the Related Art

In order to efficiently transmit data through a transmission path of a narrow band such as a public telephone line, “CCITT Recommendation V.42 bis” defines a method in which a transmission data is subjected to a compression process, the data is transmited subsequently, and decompression of the compressed data is performed on a reception side. However, by any of compressing methods which can be realized presently, it is not possible to always expect a satisfatory compression effect with data having various bit patterns. For instance, there is a case that the compression effect can hardly be expected depending on bit patterns of the data, or a case that the data size increases due to the execution of the compressing process.

To solve these problems, a mode for transmitting compressed data (hereinafter, referred to as a “compression mode”) and a mode for transmitting uncompressed data (hereinafter, referred to as an “uncompression mode”) are specified in the CCITT recommendation mentioned above. It is possible to arrange a compression apparatus to operate in the compression mode in cases where a compression effect can be expected. In cases where a compression effect cannot be expected, the apparatus is made to operate in the uncompression mode. As an example of a method for judging a condition for switching the transmission mode, there is shown a method of comparing a size of data after completion of the compressing process with the data size before compression and a result of the comparison is used for the judgement.

There is a conventional data compressing apparatus for use in a data transmitting apparatus for transmiting data through a narrow band communication path, that uses the data compression scheme specified in the recommendation described above.

In the conventional data compressing apparatus, efficient data compression and efficient data transmission on a narrow band communication path are realized by deciding whether the data compression is performed or not while monitoring an efficiency of the compression.

Incidentally, in cases where data such as audio data or image data having a very large data amount is transmitted by a narrow band communication path, it is necessary to perform an exclusively designed compression coding having a high compression ratio in consideration of characteristics that are peculiar to the data being transmitted. In a case where the second compressing process is executed in the data compressing apparatus to data which has undergone a first compressing process, an additional compression effect may not be expected. There also is a case that the data size increases due to the execution of the second compressing process.

With the structure of the data compressing apparatus mentioned above, since the transmission mode is determined by comparing the data amounts before and after the execution of the compressing process irrespective of the kind of the input data, the compression effect in the data compressing apparatus may not always be expected if the data which has undergone a compressing process is supplied to the data compressing apparatus. Accordingly, the uncompression mode is selected in most cases. Furthermore, it is supposed that the compression efficiency becomes very low even if the compression mode is selected. With the structure of the data compressing apparatus as mentioned above, the compressing process may be performed even to the data in which the compression effect can be hardly expected, so that a problem arises that a high processing load is applied to the compression apparatus.

In the field of image compression encoding or the like which is executed in consideration of a transmission via a communication path in which errors relatively often occur, there is an encoding system that gives an error resilience characteristic to the data so as to minimize a degradation of decoded data even if the compression data to which errors had been added when transmitted through the communication path is decoded. If, however, the compression data having the error resilience is further subjected to the second compressing process by the data compressing apparatus and errors are further added by the transmission path, a problem arises that the errors are diffused on the reception side due to the data decompression corresponding to the data compressing apparatus, the degradation of the compressed coded data having the error resilience is enhanced, and the effect of the error resilience will be decreased.

### OBJECTS AND SUMMARY OF THE INVENTION

The invention has been made in consideration of the problems of the conventional data compressing apparatus and it is an object of the invention to provide a novel improved data compressing apparatus which can reduce a processing burden in association with a data compressing process.

Another object of the invention is to provide a novel improved data compressing apparatus which can prevent a degradation of compression encoding data having error resilience.

To solve the problems, according to the first aspect of the invention, there is provided a data compressing apparatus for use in a data transmitting apparatus for transmitting data, comprising: transmission mode selecting means for selecting a first transmission mode or a second transmission mode in accordance with information indicating a kind of input data; data compressing means for compressing the input data and transmitting it to a data output terminal; and switching means for allowing the input data to be transmitted to the data output terminal in accordance with the first transmission mode and allowing the input data to be transmitted to the data compressing means in accordance with the second transmission mode.

According to the second aspect of the invention, the information indicating the kind of the input data is directly supplied as data independent of the input data to the transmission mode selecting means.

According to the third aspect of the invention, the information indicating the kind of the input data is additional information of the input data.

According to the fourth aspect of the invention, an example of a relation between the kind of the input data and the selection of the transmission mode by the transmission mode selecting means is as follows. That is, the information indicating the kind of the input data includes information indicating whether the input data is compression data or not, and the transmission mode selecting means selects the first transmission mode when the input data is the compression data and selects the second transmission mode when the input data is not the compression data.

With this structure, the transmission mode is selected by the transmission mode selecting means based on the signal showing the kind of the input data. Whether the data compression is performed by the data compressing means or not is discriminated in accordance with the kind of the input data. The load of the compressing process can be reduced, as a consequence.

Another example of the correlation between the kind of the input data and the selection of the transmission mode by the transmission mode selecting means is as follows. That is, the information indicating the kind of the input data includes information indicating whether the input data is data having error resilience or not, and the transmission mode selecting means selects the first transmission mode when the input data is the data having error resilience and selects the second transmission mode when the input data is data lacking error resilience. With this structure, degradation of the data having error resilience can be prevented.

A further example of the correlation between the kind of the input data and the selection of the transmission mode by the transmission mode selecting means is as follows. That is, the information indicating the kind of the input data comprises information indicating whether the input data is compressed data and information indicating whether the input data is data having error resilience or not, and the transmission mode selecting means selects the first transmission mode when the input data is either of compressed data having error resilience, compressed data lacking error resilience, and uncompressed data having error resilience, and selects the second transmission mode when the input data is uncompressed data lacking error resilience. With this structure, degradation of the data having error resilience can be prevented while eliminating the burden to perform a compression process to the data lacking error resilience.

### BRIEF DESCRIPTION OF THE DRAWINGS

FIG. 1 is an explanatory diagram of a conventional data compressing apparatus; and

FIG. 2 is an explanatory diagram of a first embodiment the data compressing apparatus according to the invention; and

FIG. 3 is an explanatory diagram of a second embodiment the data compressing apparatus according to the invention.

### DETAILED DESCRIPTION OF THE PREFERRED EMBODIMENT

The structure of a conventional data compressing apparatus will be described with reference to the drawings prior to the detailed explanation of embodiments of the present invention.

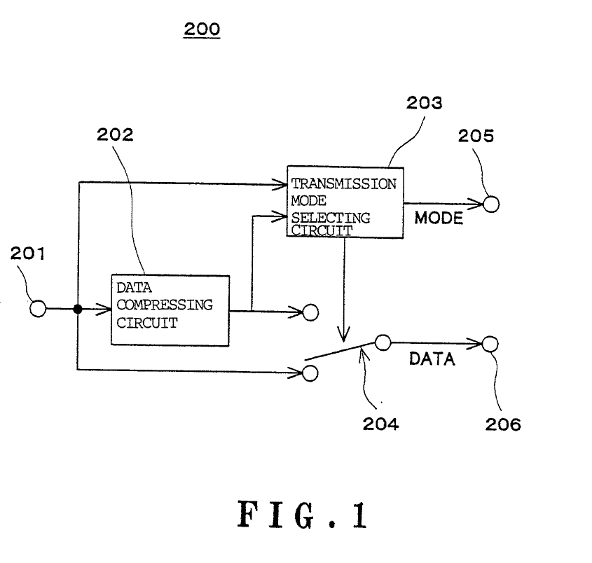

As shown in FIG. 1, a conventional data compressing apparatus 200 is generally constituted by: a data input terminal 201; a data compressing circuit 202 for compressing data which is supplied from the data input terminal 201; a transmission mode selecting circuit 203 for comparing a size of data supplied from the data input terminal 201 with a size of compression data which is generated from the data compressing circuit 202 and selecting a transmission mode; a switch 204 for selecting either the compression data or uncompression data as output data in accordance with the transmission mode selected by the transmission mode selecting circuit 203; a terminal 205 for generating a transmission mode signal MODE indicative of the transmission mode selected by the transmission mode selecting circuit 203; and a data output terminal 206 for generating data DATA selected by the switch 204.

The operation of the data compressing apparatus 200 having the above described structure will be described.

The data supplied from the data input terminal 201 is subjected to a compressing process by the data compressing circuit 202 and also supplied to the transmission mode selecting circuit 203 and switch 204. In the transmission mode selecting circuit 203, the size of data supplied from the data input terminal 201 and the size of compression data which is generated from the data compressing circuit 202 are compared and either one of the compression mode and the uncompression mode is selected as a transmission mode so as to raise a compression efficiency. A transmission mode signal indicative of the selected transmission mode is generated from the transmission mode signal output terminal 205.

The switch 204 operates in such a manner that the compressed data is outputted from the data output terminal 206 when the compression mode is selected by the transmission mode selecting circuit 203 and the uncompressed data before compression that is supplied from the data input terminal 201 is outputted from the data output terminal 206 when the uncompression mode is selected.

The conventional data compressing apparatus determines whether the compression data or the uncompressoin data is outputted while monitoring the compression efficiency. There, however, are the problems as mentioned before.

The first embodiment of a data compressing apparatus according to the invention will now be described in detail hereinafter with reference to the drawings. In the specification and the drawings, component elements having substantially the same functional construction are designated by the same reference numerals and their description will not be repeated.

In this embodiment, the data compressing apparatus is provided in a data transmitting apparatus which has a mode for compressing data and transmitting it and a mode for transmitting data without compressing it and can dynamically switch those modes for the data communication. The data compressing apparatus is characterized in that a signal showing a kind of the data is supplied from the user together with the data, a transmission mode is determined by discriminating whether the input data is data to which the compressing process has already been performed or not, and a burden of processsing data to the data compressing apparatus is reduced.

In this connection, if the data compression apparatus and a communications application are installed in a same communications system, information respresenting the kind of the data that is issued from the communications application can be directly supplied to the input terminal of the data compression apparatus by using a signal line other than the data line.

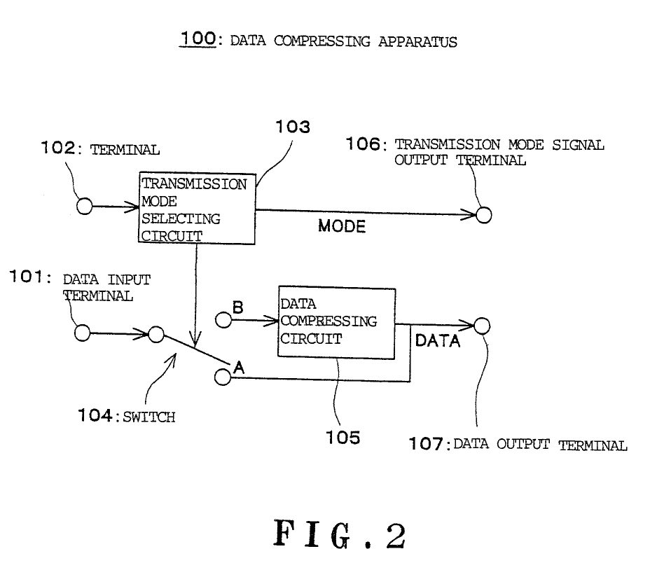

A data compressing apparatus 100 of the first embodiment of the invention will be described hereinafter with reference to FIG. 2.

As shown in FIG. 2, the data compressing apparatus 100 is generally constituted by a data input terminal 101, a terminal 102 for receiving a signal showing a kind of the data supplied from the data input terminal 101, a transmission mode selecting circuit 103 for selecting the transmission mode in accordance with the signal supplied from the terminal 102, a switch 104 for selecting whether the input data is supplied to a data compressing circuit 105 or directly outputted from a data output terminal 107 in accordance with the transmission mode selected by the transmission mode selecting circuit 103, the data compressing circuit 105 for compressing the data supplied from the data input terminal 101, a transmission mode signal output terminal 106 for generating the transmission mode signal MODE indicative of the transmission mode selected by the transmission mode selecting circuit 103, and the data output terminal 107 for generating the transmission data DATA.

The operation of the data compressing apparatus 100 with the above construction will be described.

The input data sent from the data input terminal 101 is supplied to the switch 104 and the signal showing the kind of the data is supplied to the transmission mode selecting circuit 103 from the terminal 102. The signal showing the kind of the data is a signal showing whether the input data is data which has already been compressed or uncompression data.

The transmission mode selecting circuit 103 discriminates whether the input data is data which has already been compressed or uncompression data in accordance with the signal showing the kind of the data, and selects the transmission mode. That is, in the case where the input data is the data which has already been compressed, the transmission mode is set to the uncompression mode. In the case where the input data is the uncompression data, the transmission mode is set to the compression mode. The transmission mode selecting circuit 103 generates the set transmission mode signal MODE from the transmission mode signal output terminal 106.

The switch 104 selects whether the input data is supplied to the data compressing circuit 105 or directly outputted from the data output terminal 107 in accordance with the transmission mode selected by the transmission mode selecting circuit 103. That is, when the uncompression mode is selected by the transmission mode selecting circuit 103, the switch 104 is switched to the terminal A and the data input terminal 101 is directly connected to the data output terminal 107. When the compression mode is selected by the transmission mode selecting circuit 103, the switch 104 is operated to connects its movable terminal to the terminal B so that the data input terminal 101 is connected to the data compressing circuit 105.

When the compression mode is selected by the transmission mode selecting circuit 103 and the switch 104 is switched to the terminal B, the input data is supplied to the data compressing circuit 105. The data compressing circuit 105 performs the compressing process to the input data and outputs the compression data from the data output terminal 107.

In the embodiment, the apparatus has the terminal 102 for receiving the signal indicative of the kind of the input data and the transmission mode is selected by the transmission mode selecting circuit 103 on the basis of the signal indicative of the kind of the input data. In the case where the input data is the data which has already been compressed, the uncompression mode is selected as a transmission mode and the compressing process is not performed. Only when the compression mode is selected as a transmission mode, the compressing process is performed by the data compressing circuit 105. The processing load to the compressing process, therefore, can be reduced.

In the case of the second embodiment of the data compression apparatus, the input data itself has the additional information including the kind of the data, and the kind of the data is discriminated from the additional information of the input data instead of directly applying the data kind information to a terminal of the data compressing apparatus through a signal line other than the data line.

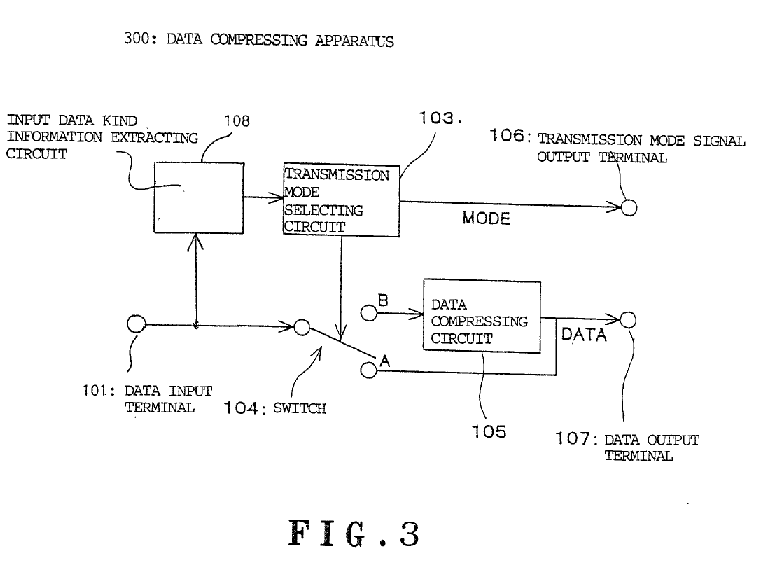

Hereinafter, explanation will be made with reference to FIG. 3, for a data compression apparatus 300 presented as the second embodiment of the present invention. In the explanation, only portions of the structure that are different from the data compression apparatus 100 presented as the first embodiment will be explained in detail. The data compression apparatus 300 has a configuration that the type of the data is judged by means of additional information of the input data.

As shown in FIG. 3, the data compression apparatus of this embodiment is provided with an input data kind information extracting circuit 108. The input data kind information extracting circuit 108 extracts additional information that is added to the input data supplied through the input terminal 101, and supplies a signal representing the kind of the input data to the transmission mode selecting circuit 103. As in the case of the first embodiment, the signal representing the kind of the input data is a signal indicating whether the input data is data already compressed or the uncompressed data.

The data received at the data input terminal 101 is supplied to the input data kind information extracting circuit 108 in addition to the switch 104.

The data kind information is added as a header information, for example, to each of data units that are produced by dividing data outputted from a communications application for instance. Thus, an output data to which the data type information is added is supplied to the input terminal 101.

In the following part, explanation will be made on the operation of the data compression apparatus 300 comprising the elements described above.

The input data inputted trough the data input terminal 101 is supplied to the switch 104, and to the input data kind information extracting circuit 108 as well.

The input data kind information extracting circuit 108 extracts the data kind information for each of the data units of the received input data, and supplies the signal represending the kind of the input data to the transmission mode selecting circuit 103. Based on the signal represending the kind of the input data, the transmission mode selecting circuit 103 sets the uncompressing mode, and supplies a signal that controls the switch 104 to connect its movable terminal to the terminal A when the input data kind information indicates that the input data is compressed data. When, on the other hand, the input data kind information indicates that the input data is not compressed data, the transmission mode selecting circuit 103 sets the compressing mode and supplies to the switch 104 a signal that controls the switch 104 to connect its movable terminal to the terminal B.

Since the remaining parts of the apparatus 300 shown in FIG. 3 are the same as those of the first embodiment of the data compression apparatsu 100 depicted in FIG. 2, the explanation thereof will not be repeated.

In the first and second embodiments, the transmission mode is selected depending on whether or not the input signal has already been compressed. The third embodiment, on the other hand, features that the transmission mode is selected depending on whether or not the input data has error resilience.

There are the following two configurations as the configuration to be employed when the transmission mode is selected depending on whether or not the input data has error resilience. The first configuration is for use in the data compression apparatus 100 shown in FIG. 2 that is presented as the first embodiment.

In this configuration, the information representing the kind of the data supplied through the terminal 101 is supplied to the input terminal 102 of the data compression apparatus. In this case, the information representing the kind of data is a signal indicating as to whether or not the input data has error resilience. This signal is supplied to the terminal 102 of the data compressing apparatus directly through a signal line that is different from the data line, as in the case of the first embodiment.

In this case, the transmission mode selecting circuit 103 judges as to whether or not the input data is data having error resilience in accordance with the signal representing the kind of data, and selects a transmission mode.

Specifically, the transmission mode selecting circuit 103 sets the transmission mode to the uncompressing mode when the supplied information representing the kind of the data indicates that the input data is data coded to have the error resilience. When, on the other hand, the supplied information representing the kind of the data indicates that the input data is data that is not coded to have the error resilience, the transmission mode selecting circuit 103 selects the compression mode.

When the input data has error resilience, the switch 104 is operated to connect to the contact A so that the input data is outputted directly. When the input data does not have error resilience, the switch 104 is operated to connect to the contact B, so that the input data is spupplied to the data compression circuit 105. Other operations of the apparatus are the same as those of the data compression apparatus of the first embodiment shown in FIG. 1.

The second method is for use in the data compression apparatus 300 of the second embodiment shown in FIG. 3. The data supplied through the data input terminal 101 has additional information representing the kind of the input data.

In this case, the input data kind information extracting circuit 108 extracts the data kind information added to each of the data units of the input data, and supplys the signal representing the kind of input data to the transmission mode selecting circuit 103. The signal representing the kind of input data is a signal representing whether or not the data has error resilience. In accordance with the signal representing the kind of the input data, the transmission mode selecting circuit 103 selects a transmission mode.

When the data kind information indicates that the input data is data coded to have the error resilience, the transmission mode selecting circuit 103 sets the transmission mode to the uncompressing mode. When the input data is a data not coded to have error resilience, the transmission mode selecting circuit 103 selects the compression mode.

When the input data has error resilience, the trasnsmission mode selecting circuit 103 supplies, to the switch 104, the control signal to connect the movable terminal to the terminal A. When, on the other hand, the input data does not have error resilience, the transmission mode selecting circuit 103 supplies the control signal to control the switch 104 to connent the movable terminal to the terminal B.

Other operations of the apparatus are the same as those of the data compression apparatus 300 of the second embodiment.

In the first and second embodiments, the selection of transmission mode is performed based on the information as to whether the input data has been compressed or not. In the case of the third embodiment, the information as to whether or not the input data has error resilience is used. The fourth embodiment features that one of four sorts of information formed by the assemble of the above two sorts of information is included in the information of the kind of the input data.

In the fourth embodiment, the information of the kind of input data falls in any one of four sorts of information composed of the information piece indicating whether the input data is compressed data or uncompressed data and the information piece indicating whether or not the input data is data coded to have error resilience.

Either of the data compressing apparatus 100 of the first embodiment and the data compressing apparatus 300 of the second embodiment may be used as the structure for handling the information comprising one of these four sorts of information.

That is, when the data compressing apparatus 100 of the first embodiment shown in FIG. 1 is employed, the signal represending the kind of data supplied to the input terminal 102 becomes a signal representing one of the above-mentioned four sorts of information. When the data compressing apparatus 300 of the second embodiment shown in FIG. 3 is employed, the data supplied through the input terminal 101 is adapted to have additional information that includes one of the four sorts of information mentioned above.

The transmission mode selecting circuit 103, that is a common component in the first and second embodiments, sets the transmission mode to the uncompression mode when the signal indicating the kind of input data indicates any of the compressed data having error resiliency, the compressed data lacking error resiliency, and the uncompressed data lacking error resiliency. The circuit 103 set the transmission mode to the compression mode when the signal indicating the kind of input data indicates the uncompressed data lacking error resiliency.

When the uncompression mode is set, the switch 104 is operated to connect its movable contact to the contact A so that the input data is directly outputted. When on the other hand the compression mode is selected, the switch 104 is operated to connect its movable contact to the contace B, so that the input data is supplied to the data compression circuit 105.

Other operations of the apparatus are the same as the data compression apparatus 100 or 300 in the first and second modes.

The preferred embodiments of the data compressing apparatus according to the invention have been described above with reference to the drawings. It is needless to mention that the invention is not limited to this example. It will be readily understood that those skilled in the art can easily presume various modifications and variations within the purview of the technical idea disclosed in the scope of claim for a patent and that they are apparently incorporated in the technical range of the invention.

For example, in the case of the embodiment described above, the compression mode is always selected when the input data is uncompressed data. However, it is possible to design the apparatus in such a way to select the trasmission mode, when the input data is uncompressed data, by monitoring the data amounts before and after the compression as in the case of the conventional apparatus.

As described above, according to the invention, the apparatus has the input terminal of the signal indicative of the kind of input data and the transmission mode is selected by the transmission mode selecting circuit based on the signal indicative of the kind of input data. In the case where the input data is the data which has already been compressed, the uncompression mode is selected as a transmission mode and the compressing process is not performed and, only when the compression mode is selected as a transmission mode, the compressing process is performed by the data compressing circuit. The load of the compressing process, therefore, can be reduced.

Furthermore, by to addition of information represending the kind of input data to the input data, the number of input terminals to the data compression apparatus can be reduced, so that, when the application device or software which provides the transmission data and the data compressing apparatus are mutually connected through communication channels, the number of the necessary communication channels can be reduced.

In the case of the transmision of the data having error resilience, the degradation of the compression encoding data having the error resilience can be prevented by discriminating the transmission mode in dependence on whether or not the input data has error resilience.

Furthermore, by using the information as to whether the input data is data having error resilience or data lacking error resilience besides the information as to whether the input data is compressed data or uncompressed data, degradation of the data having error resilience can be prevented while alleviating the burden of performing a compression process to the data lacking error resilience.

What is claimed is:

1. A data compressing apparatus for use in a data transmitting apparatus for transmitting data, comprising:
transmission mode selecting means for selecting a first transmission mode or a second transmission mode in accordance with information indicating a kind of input data;
data compressing means for compressing said input data and transmitting it to a data output terminal; and
switching means for allowing said input data to be transmitted to said data output terminal in accordance with said first transmission mode and allowing said input data to be transmitted to said data compressing means in accordance with said second transmission mode.

2. An apparatus according to claim 1, wherein the information indicating the kind of said input data is directly supplied as data independent of said input data to said transmission mode selecting means.

3. An apparatus according to claim 1, wherein the information indicating the kind of said input data is additional information of said input data.

4. An apparatus according to any one of claim 1, wherein the information indicating the kind of said input data includes information indicating whether said input data is compression data or not, and said transmission mode selecting means selects said first transmission mode when said input data is the compression data and selects said second transmission mode when said input data is not the compression data.

5. An apparatus according to claim 2, wherein the information indicating the kind of said input data includes information indicating whether said input data is compression data or not, and said transmission mode selecting means selects said first transmission mode when said input data is the compression data and selects said second transmission mode when said input data is not the compression data.

6. An apparatus according to claim to 3, wherein the information indicating the kind of said input data includes information indicating whether said input data is compression data or not, and said transmission mode selecting means selects said first transmission mode when said input data is the compression data and selects said second transmission mode when said input data is not the compression data.

7. An apparatus according to claim 1, wherein the information indicating the kind of said input data includes information indicating whether said input data is data having error resilience or not, and said transmission mode selecting means selects said first transmission mode when said input data is the data having the error resilience and selects said second transmission mode when said input data is data that kacks error resilience.

8. An apparatus according to claim 2, wherein the information indicating the kind of said input data includes information indicating whether said input data is data having error resilience or not, and said transmission mode selecting means selects said first transmission mode when said input data is the data having the error resilience and selects said second transmission mode when said input data is data that lacks error resilience.

9. An apparatus according to claim 3, wherein the information indicating the kind of said input data includes information indicating whether said input data is data having error resilience or not, and said transmission mode selecting means selects said first transmission mode when said input data is the data having error resilience and selects said second transmission mode when said input data is data that lacks error resilience.

10. An apparatus according to claim 1, wherein the information indicating the kind of said input data includes information indicating whether or not said input data is compression data and information indicating whether or not said input data is data having error resilience, and said transmission mode selecting means selects said first transmission mode when said input data is one of data that is compressed and has error resilience, data that is compressed and lacks error resilience and data that is uncompressed and has error resilience, and selects said second transmission mode when said input data is data that is uncompressed and lacks error resilience.

11. An apparatus according to claim 2, wherein the information indicating the kind of said input data includes information indicating whether or not said input data is compression data and information indicating whether or not said input data is data having error resilience, and said transmission mode selecting means selects said first transmission mode when said input data is one of data that is compressed and has error resilience, data that is compressed and lacks error resilience and data that is uncompressed and has error resilience, and selects said second transmission mode when said input data is data that is uncompressed and lacks error resilience.

12. An apparatus according to claim 3, wherein the information indicating the kind of said input data includes information indicating whether or not said input data is compression data and information indicating whether or not said input data is data having error resilience, and said transmission mode selecting means selects said first transmission mode when said input data is one of data that is compressed and has error resilience, data that is compressed and lacks error resilience and data that is uncompressed and has error resilience, and selects said second transmission mode when said input data is data that is uncompressed and lacks error resilience.
